(19) United States
(12) Patent Application Publication
(10) Pub. No.: US 2016/0181664 A1
(43) Pub. Date: Jun. 23, 2016

(54) ELECTROLYTE FOR SODIUM ION SECONDARY BATTERY

(71) Applicant: TOYO GOSEI CO., LTD., Chiba (JP)

(72) Inventor: Daisuke Sakemi, Chiba (JP)

(73) Assignee: TOYO GOSEI CO., LTD., Chiba (JP)

(21) Appl. No.: 14/972,593

(22) Filed: Dec. 17, 2015

Related U.S. Application Data
(60) Provisional application No. 62/093,922, filed on Dec. 18, 2014.

(30) Foreign Application Priority Data
Nov. 24, 2015 (JP) 2015-228409

(51) Int. Cl. H01M 10/0568; H01M 10/054

(52) U.S. Cl. CPC H01M 10/0568; H01M 10/054; H01M 2300/0025

(57) ABSTRACT

Provided is an electrolyte solution for secondary batteries that has safety properties of non-flammability and nonvolatility thanks to the use of an ionic liquid and that can alleviate the decrease in electric conductivity and the increase in the internal resistance of the battery during low-temperature operation.

### TECHNICAL FIELD

Some aspects of the present invention relate to an electrolyte solution for sodium ion secondary batteries that comprises an allylimidazolium salt and has a low viscosity, a high electric conductivity and a low melting point.

### BACKGROUND ART

Electrolyte solutions containing an organic solvent as a main component, which have been used in secondary batteries such as lithium ion batteries, are generally flammable and volatile.

Such electrolyte solutions may generate heat when the secondary battery is overcharged or short-circuited, or may ignite or catch fire when the secondary battery is used under a high-temperature condition. That is, these electrolyte solutions have a problem with safety.

Typically, for this reason, attempts to use ionic liquids as electrolyte solutions are being made in recent years thanks to the properties thereof (for example, see Japanese Re-Publication of PCT International Publication No. 2013/141242). An ionic liquid, which is an ionic substance in the liquid state, has properties of non-flammability and nonvolatility, and can avoid the safety problem that the conventional electrolyte solutions have.

### SUMMARY OF INVENTION

However, an electrolyte solution comprising an ionic liquid typically has a high melting point, as well as has a property of becoming more viscous at low temperatures. Accordingly, during low-temperature operation, the battery suffers from a decrease in electric conductivity and an increase in internal resistance. These problems have restricted the operating environment of secondary batteries comprising an ionic-liquid electrolyte and have been a major barrier to developing the application thereof.

Some aspects of the present invention have been made in view of the foregoing. An object on an aspect of the present invention is to provide an electrolyte solution for sodium ion secondary batteries that has safety properties of non-flammability and nonvolatility thanks to the use of an ionic liquid, and that can alleviate the decrease in electric conductivity and the increase in the internal resistance of the battery during low-temperature operation.

According to some aspects of the present invention, there is provided an electrolyte solution for sodium ion secondary batteries comprising an allylimidazolium salt represented by General Formula (1) and a sodium ion-containing electrolyte:

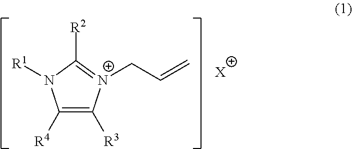

wherein R¹ is selected from the consisting of: a linear, branched, or cyclic C1 to C10 alkyl group optionally substituted by a substituent; a linear, branched, or cyclic C2 to C10 alkenyl group optionally substituted by a substituent; a linear, branched, or cyclic C2 to C10 alkynyl group optionally substituted by a substituent; an aromatic hydrocarbon group optionally substituted by a substituent; an aromatic heterocyclic group optionally substituted by a substituent; and a univalent group having a heteroatom in a part of the alkyl group, the alkenyl group, or the alkynyl group;
R² to R⁴ may be the same or different and are each a hydrogen atom, or a hydrocarbon group optionally substituted by a substituent; and
X⁻ is a counter anion.

The present inventor conducted investigations for the purpose of alleviating the decrease in electric conductivity and the increase in the internal resistance of a sodium ion secondary battery comprising an ionic-liquid electrolyte solution during low-temperature operation. The inventor then found that the above purpose was achieved when using an allylimidazolium salt and completed the present invention. An imidazolium salt having an allyl group in an aspect of the present invention has properties of a low viscosity, a high electric conductivity and a low melting point, and exhibits excellent performance as an electrolyte solution for electrochemical devices, particularly during low-temperature operation.

Various embodiments of the present invention are described below. The embodiments below can be combined with each other.

Preferably, the counter anion of the allylimidazolium salt is an anion represented by General Formula (2),

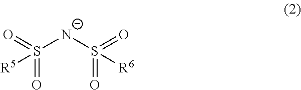

wherein R⁵ and R⁶ may be the same or different and are each a fluorine atom, or a hydrocarbon group in which at least one hydrogen atom may be optionally substituted by a fluorine atom.

Preferably, R¹ is a C1 to C10 alkyl group.

Preferably, R¹ is a C1 to C3 alkyl group.

Preferably, the counter anion of the allylimidazolium salt is a bis(fluorosulfonyl)imide anion.

Preferably, a concentration of the sodium ion-containing electrolyte is from 5 to 60 mol %.

According to another aspect of the present invention, there is provided a sodium ion secondary battery including the above electrolyte solution.

The electrolyte solution for sodium ion secondary batteries according to some aspects of the present invention has safety properties of non-flammability and nonvolatility, and can alleviate the decrease in electric conductivity and the increase in the internal resistance of the battery during low-temperature operation.

### BRIEF DESCRIPTION OF THE DRAWINGS

FIG. 1 illustrates DSC curves of AEI-FSI and EPI-FSI.

FIG. 2 illustrates the configuration of a sodium ion secondary battery.

FIG. 3 illustrates a graph of the electric conductivities of AEI-FSI and EPI-FSI at respective temperatures.

FIG. 4 illustrates a graph of the electric conductivities of AMI-FSI and AEI-FSI at respective temperatures.

FIG. 5 illustrates a graph of the viscosities of AEI-FSI and EPI-FSI at respective temperatures.

FIG. 6 illustrates a graph of the viscosities of AMI-FSI and AEI-FSI at respective temperatures.

FIG. 7 illustrates a graph of the electric conductivities of AEI-FSI and EPI-FSI containing 40 mol % of NaFSI at respective temperatures.

FIG. 8 illustrates a graph of the electric conductivities of AMI-FSI and AEI-FSI containing 40 mol % of NaFSI at respective temperatures.

FIG. 9 illustrates a graph of the viscosities of AEI-FSI and EPI-FSI containing 40 mol % of NaFSI at respective temperatures.

FIG. 10 illustrates a graph of the viscosities of AMI-FSI and AEI-FSI containing 40 mol % of NaFSI at respective temperatures.

FIG. 11 illustrates a graph of the electric conductivity and viscosity of AEI-FSI in respective NaFSI concentrations at 25° C.

### DESCRIPTION OF EMBODIMENTS

Now, an embodiment of some aspects of the present invention will be described. Various features described in the embodiment below can be combined with each other. However, inventions are established for the respective features.

### 1. Allylimidazolium Salt

An electrolyte solution for sodium ion secondary batteries according to some aspects of the present invention contains an imidazolium salt. Preferably, the imidazolium salt is an allylimidazolium salt in which a substituent on at least one nitrogen atom of a compound represented by General Formula (1) is an allyl group.

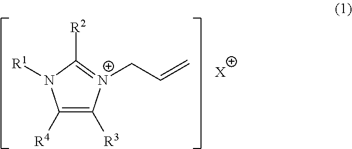

In Formula (1), R¹ is selected from the group consisting of: a linear, branched, or cyclic C1 to C10 alkyl group optionally substituted by a substituent; a linear, branched, or cyclic C2 to C10 alkenyl group optionally substituted by a substituent; a linear, branched, or cyclic C2 to C10 alkynyl group optionally substituted by a substituent; an aromatic hydrocarbon group optionally substituted by a substituent; an aromatic heterocyclic group optionally substituted by a substituent; and a univalent group having a heteroatom in a part of the alkyl group, the alkenyl group, or the alkynyl group. R² to R⁴ may be the same or different and are each a hydrogen atom, or a hydrocarbon group in which at least one hydrogen atom is optionally substituted by a substituent. X⁻ is a counter anion.

### <Substituent of Allylimidazolium Salt>

In Formula (1), a substituent R¹ on a nitrogen atom not substituted by an allyl group, of two nitrogen atoms is selected from the group consisting of: a hydrogen atom; a linear, branched, or cyclic C1 to C10 alkyl group optionally substituted by ubstituent; a linear, branched, or cyclic C2 to C10 alkenyl group optionally substituted by a substituent; a linear, branched, or cyclic C2 to C10 alkynyl group optionally substituted by a substituent; an aromatic hydrocarbon group optionally substituted by a substituent; an aromatic heterocyclic group optionally substituted by a substituent; and a univalent group having a heteroatom on a main chain or skeleton of the alkyl group, the alkenyl group, the alkynyl group, or the aromatic hydrocarbon group.

Examples of the univalent group having a heteroatom in a part of the alkyl group, alkenyl group, or alkynyl group include a group in which at least one of the methylen group of the alkyl group, alkenyl group, or alkynyl group is substituted by a heteroatom-containing group selected from the group consisting of —O—, —CO—, —COO—, —OCO—, —O—CO—O—, —NHCO—, —CONH—, —NH—CO—O—, —O—CO—NH—, —NH—, —S—, and —CO—O—CH₂—CO—O—.

Examples of the linear, branched, or cyclic C1 to C10 alkyl group include C1 to C10 linear alkyl groups, such as methyl, ethyl, propyl, butyl, and octyl groups; C3 to C10 branched alkyl groups, such as isopropyl and isobutyl groups; and C3 to C10 cyclic alkyl groups, such as cyclopenthyl and cyclohexyl groups.

Examples of the alkenyl group or alkynyl group include a group in which at least one of the carbon-carbon single bond of the alkyl group is substituted by a carbon-carbon double bond or carbon-carbon triple bond.

Examples of the aromatic hydrocarbon group include C6 to C10 groups, such as phenyl, naphthyl, and anthryl groups.

Examples of the aromatic heterocyclic group include groups having a skeleton, such as furan, thiophene, pyrrole, imidazole, pyran, pyridine, pyrimidine, pyrazine, indole, purine, quinoline, isoquinoline, chromene, chromone, coumarin, thianthrene, dibenzothiophene, phenothiazine, phenoxazine, xanthene, acridine, phenazine, and carbazole.

Examples of the substituent by which the alkyl group or the like represented by R¹ is optionally substituted include alkyl groups, such as methyl and ethyl groups; aromatic hydrocarbon groups, such as phenyl, naphthyl, and anthryl groups; alkyloxy groups, such as a methoxy group; aryloxy groups, such as a phenoxy group; alkylthio groups, such as a methylthio group; arylthio groups, such as a phenylthio group; acyl groups, such as an acetyl group; aroyl groups, such as a benzoyl group; acyloxy groups, such as an acetoxy group; aroyloxy groups, such as a benzoyloxy group; nitrile groups; and nitro groups.

The substituent R¹ is preferably a C1 to C10 alkyl group, more preferably a C1 to C3 alkyl group, even more preferably a C1 to C3 linear alkyl group, most preferably a methyl or ethyl group which is a C1 to C2 linear alkyl group. The reason is that the electric conductivity tends to be increased when the volume of cations is properly reduced.

In Formula (1), the substituents R² to R⁴ on carbon may be the same or different and are each a hydrogen atom, or a hydrocarbon group optionally substituted by a substituent.

Examples of the hydrocarbon group include alkyl groups, such as methyl, ethyl, propyl, butyl, and octyl groups; cycloalkyl groups, such as cyclopenthyl and cyclohexyl groups; and aromatic hydrocarbon groups, such as phenyl, naphthyl, and anthryl groups.

At least one of the methylen groups of the hydrocarbon group is optionally substituted by a heteroatom-containing group selected from the group consisting of —O—, —CO—, —COO—, —OCO—, —O—CO—O—, —NHCO—, —CONH—, —NH—CO—O—, —O—CO—NH—, —NH—, —S—, and —CO—O—CH₂—CO—O—.

Examples of the substituent by which the hydrocarbon group or the like represented by each of R² to R⁴ is optionally substituted include alkyl groups, such as methyl and ethyl groups; aromatic hydrocarbon groups, such as phenyl, naphthyl, and anthryl groups; alkyloxy groups, such as a methoxy group; aryloxy groups, such as a phenoxy group; alkylthio groups, such as a methylthio group; arylthio groups, such as a phenylthio group; acyl groups, such as an acetyl group; aroyl groups, such as a benzoyl group; acyloxy groups, such as an acetoxy group; aroyloxy groups, such as a benzoyloxy group; nitrile groups; and nitro groups.

The substituents R² to R⁴ are preferably hydrogen atoms or C1 to C5 hydrocarbon groups. The reason is that the electric conductivity tends to be increased when the volume of cations is properly reduced.

Preferred examples of an allylimidazolium cation obtained by combining the substituents R¹ to R⁴ include 1-allyl-3-methylimidazolium, 1-allyl-3-ethylimidazolium, 1-allyl-3-n-propylimidazolium, 1-allyl-3-isopropylimidazolium, 1-allyl-3-n-butylimidazolium, 1-allyl-3-isobutylimidazolium, 1-allyl-3-sec-butylimidazolium, 1-allyl-3-tert-butylimidazolium, 1-allyl-3-n-pentylimidazolium, 1-allyl-3-isopentylimidazolium, 1-allyl-3-n-hexylimidazolium, 1-allyl-3-n-heptylimidazolium, 1-allyl-3-n-octylimidazolium, 1,3-diallylimidazolium, 1-allyl-3-cyclopentylimidazolium, 1-allyl-3-methylcyclopentylimidazolium, 1-allyl-3-cyclohexylimidazolium, 1-allyl-3-vinylimidazolium, 1-allyl-3-(1-propenyl)imidazolium, 1-allyl-3-(2-butenyl)imidazolium, and 1-allyl-3-(3-butenyl)imidazolium. The allylimidazolium cation is preferably 1-allyl-3-methylimidazolium (AMI), 1-allyl-3-ethylimidazolium (AEI), or 1-allyl-3-n-propylimidazolium, more preferably 1-allyl-3-methylimidazolium (AMI) or 1-allyl-3-ethylimidazolium (AEI), even more preferably 1-allyl-3-ethylimidazolium (AEI).

When a salt with a bis(fluorosulfonyl)imide anion is used, AEI has a lower viscosity than AMI and a higher electric conductivity in a temperature within the range of 25 to 50° C. than AMI. That is, AEI-FSI is better than AMI-FSI as an ionic-liquid electrolyte solution for alleviating the increase in the internal resistance of a sodium ion secondary battery during low-temperature operation. Accordingly, AEI is more preferable as an example of the allylimidazolium cation.

### <Counter Anion of Allylimidazolium Salt>

The counter anion of the allylimidazolium salt may be of any type and, for example, BF₄_{^{−}} or PF₆_{^{−}}.

Preferably, the counter anion of the allylimidazolium salt is an anion represented by General Formula (2) below.

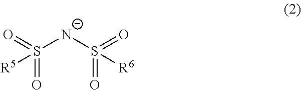

In Formula (2) above, R⁵ and R⁶ may be the same or different and are each a fluorine atom, or a hydrocarbon group in which at least one hydrogen atom may be optionally substituted by a fluorine atom. R⁵ and R⁶ are each preferably a fluorine atom, or an alkyl group in which at least one hydrogen atom may be optionally substituted by a fluorine atom, more preferably a fluorine atom or a C1 to C5 alkyl group in which at least one hydrogen atom may be substituted by a fluorine atom, even more preferably a fluorine atom or a trifluoromethyl group, most preferably a fluorine atom.

Specifically, the counter anion of the allylimidazolium salt is a bis(sulfonyl)imide anion, such as a bis(trifluoromethylsulfonyl)imide anion (TFSI), bis(pentafluoroethylsulfonyl)imide anion, trifluoromethylsulfonyl(nonafluorobutylsulfonyl)imide anion, or bis(fluorosulfonyl)imide anion (FSI).

FSI has a smaller anion volume than TFSI, and the like. Further, in FSI, a fluorine atom is directly bonded to a sulfur atom. Accordingly, it is thought that a negative charge on a nitrogen atom is delocalized due to the conjugation through the p orbital of the fluorine atom; the interaction with a cation is relatively weak; and the ion is more likely to be dissociated. For this reason, FSI is preferred in terms of viscosity and electric conductivity. In TFSI and the like, on the other hand, a fluorine atom of a trifluoromethyl group is bonded to a sulfur atom via a carbon atom. Accordingly, there is no direct bonding between the fluorine atom and sulfur atom (S—F), and conjugation is less likely to occur therebetween. For this reason, FSI is believed to have a higher effect by delocalization than TFSI and the like.

The imidazolium salt according to some aspects of the present invention contains an allyl group, and thus has a lower melting point and a lower viscosity. For example, while 1-ethyl-3-n-propylimidazolium bis(fluorosulfonyl)imide (EPI-FSI) and 1-allyl-3-ethylimidazolium bis(fluorosulfonyl)imide (AEI-FSI) have the same number of carbon atoms, AEI-FSI has a lower melting point than EPI-FSI by 16° C. and is suitable for use in a lower-temperature environment.

Further, AEI-FSI has a lower viscosity than EPI-FSI and a higher electric conductivity in a temperature within the range of −20 to 50° C. than EPI-FSI. That is, AEI-FSI is better than EPI-FSI as an ionic-liquid electrolyte solution for alleviating the increase in the internal resistance of a sodium ion secondary battery during low-temperature operation.

### <Viscosity of Allylimidazolium Salt>

The viscosity (mPa·s) of the allylimidazolium salt according to some aspects of the present invention is preferably 25.0 or less at 25° C., more preferably 22.0 or less, even more preferably 21.0 or less, particularly preferably 20.0 or less. The reason is that when the viscosity is 25.0 or less, the electric conductivity at low temperatures tends to be increased.

The viscosity (mPa·s) of the allylimidazolium salt according to some aspects of the present invention is preferably 12.0 or less at 50° C., more preferably 11.5 or less, even more preferably 11.0 or less, particularly preferably 10.5 or less. The reason is that when the viscosity is 12.0 or less, the electric conductivity at low temperatures tends to be increased.

### 2. Sodium Ion-Containing Electrolyte

An electrolyte solution for sodium ion secondary batteries according to some aspects of the present invention contains an allylimidazolium salt and a sodium ion-containing electrolyte. The sodium ion-containing electrolyte is a sodium salt, and can be used by combining sodium cations and various types of counter anions.

### <Counter Anion of Sodium Salt>

Examples of the counter anion of the sodium salt include a fluoride ion, a chloride ion, a bromide ion, an iodide ion, a fluoroborate ion, a hexafluorophosphoric acid ion, a trifluoromethanesulfonic acid ion, a perchloric acid ion, and an anion represented by General Formula (2) below. These ions may be used singly or in combination.

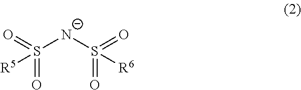

In Formula (2) above, R⁵ and R⁶ may be the same or different and are each a fluorine atom, or a hydrocarbon group in which at least one hydrogen atom may be optionally substituted by a fluorine atom. R⁵ and R⁶ are each preferably a fluorine atom, or an alkyl group in which at least one hydrogen atom may be optionally substituted by a fluorine atom, more preferably a fluorine atom, or a C1 to C5 alkyl group in which at least one hydrogen atom may be substituted by a fluorine atom, even more preferably a fluorine atom or a trifluoromethyl group, most preferably a fluorine atom.

Specifically, R⁵ and R⁶ are bis(sulfonyl)imide anions, such as a bis(trifluoromethylsulfonyl)imide anion (TFSI), a bis(pentafluoroethylsulfonyl)imide anion, a trifluoromethylsulfonyl(nonafluorobutylsulfonyl)imide anion, and a bis(fluorosulfonyl)imide anion (FSI).

FSI has a smaller anion volume than TFSI and the like. Further, in FSI, a fluorine atom is directly bonded to a sulfur atom. Accordingly, it is thought that a negative charge on a nitrogen atom is delocalized due to the conjugation through the p orbital of the fluorine atom; the interaction with a cation is relatively weak; and the ion is more likely to be dissociated. Accordingly, FSI is preferred in terms of viscosity and electric conductivity. In TFSI and the like, on the other hand, a fluorine atom of a trifluoromethyl group is bonded to a sulfur atom via a carbon atom. Accordingly, there is no bond between the fluorine atom and sulfur atom (S—F), and conjugation is less likely to occur therebetween. For this reason, FSI is believed to have a higher delocalization effect than TFSI and the like.

### 3. Electrolyte Solution for Secondary Batteries

An electrolyte solution for sodium ion secondary batteries according to some aspects of the present invention contains the above imidazolium salt and the sodium ion-containing electrolyte.

### <Content of Imidazolium Salt>

The content of the imidazolium salt in the electrolyte solution is preferably 10 mol % or more, more preferably 30 mol % or more, even more preferably 40 mol % or more, particularly preferably 50 mol % or more. It is preferably 95 mol % or less, more preferably 80 mol % or less, even more preferably 70 mol % or less.

### <Concentration of Sodium Ion-Containing Electrolyte>

The electrolyte solution for sodium ion secondary batteries according to some aspects of the present invention uses, as a solvent, the imidazolium salt having a particular structure. Thus, it is possible to reduce the viscosity and thus to increase the concentration of the sodium ion-containing electrolyte. As a result, the capacities of sodium-ion secondary batteries can be increased. However, the viscosity of the electrolyte solution tends to be increased when the concentration of the sodium ion-containing electrolyte tends to be increased.

To achieve both a reduction in the viscosity of the electrolyte solution for sodium-ion secondary batteries and an increase in the capacity so as to increase the battery efficiency, the concentration (mol %) of the sodium ion-containing electrolyte is preferably 5 mol % or more, more preferably 20 mol %, even more preferably 30 mol % or more. It is preferably 90 mol % or less, more preferably 70 mol % or less, even more preferably 60 mol % or less, particular preferably 50 mol % or less.

### <Other Components>

The electrolyte solution for sodium ion secondary batteries according to some aspects of the present invention may contain the imidazolium salt and the sodium ion-containing electrolyte, as well as other components, as long as the effects of the present invention are not impaired.

### <Ion Battery>

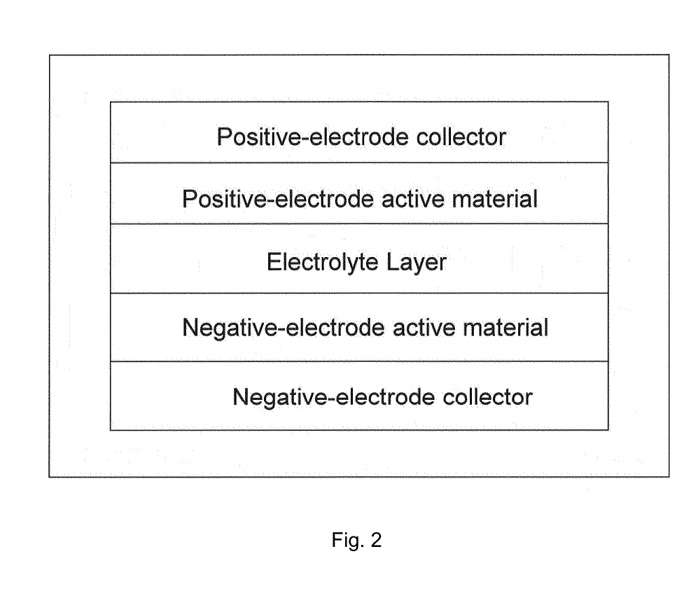

FIG. 2 illustrates the configuration of an apparatus comprising the electrolyte solution for sodium ion secondary batteries containing the allylimidazolium salt and sodium ion-containing electrolyte according to some aspects of the present invention. A typical example of the apparatus is a secondary battery having a positive-electrode collector, a negative-electrode collector, a positive-electrode active material, a negative-electrode active material, and an electrolyte layer disposed in a battery case. The positive-electrode active material, the negative-electrode active material, and the electrolyte layer are disposed between the positive-electrode collector and the negative-electrode collector. The electrolyte layer is disposed between the positive-electrode active material and the negative-electrode active material. If an electrolyte layer containing the above electrolyte solution for sodium ion secondary batteries is used as this electrolyte layer, the increase in the internal resistance of the battery during low-temperature operation is alleviated.

### EXAMPLE

Now, specific Examples of the some aspects of the present invention will be described. However, the present invention is not limited thereto.

### <Synthesis of Imidazolium Salt>

There will be described typical Preparation Examples of the imidazolium salt according to some aspects of the present invention illustrated in Formulas (3-1) to (3-3) below.

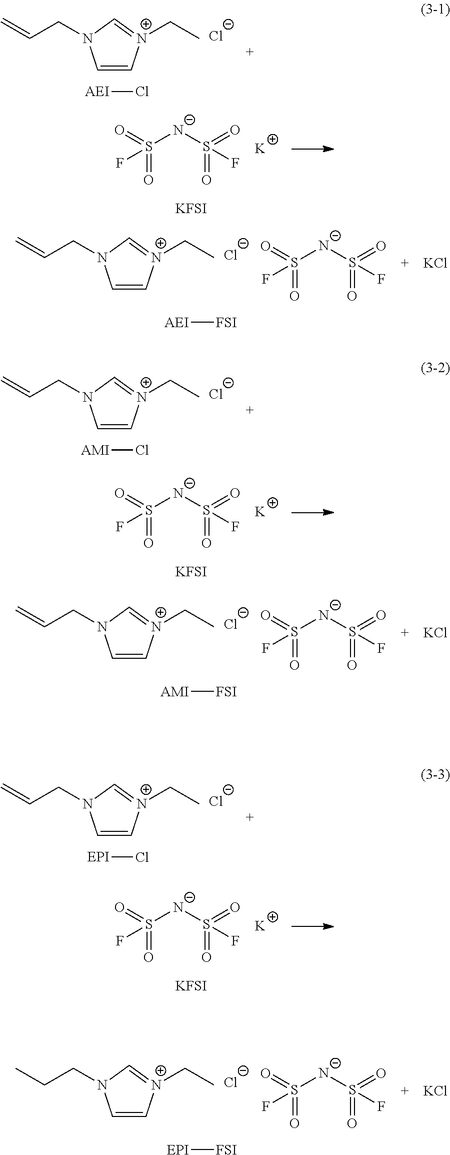

### Preparation Example 1

### 1-allyl-3-ethylimidazolium bis(fluorosulfonyl)imide (AEI-FSI)

To a dichloromethane solution of potassium bis(fluorosulfonyl)imide (KFSI) were added a dichloromethane solution of 1-allyl-3-ethylimidazolium chloride (AEI-Cl) and water. The mixture was stirred for 1 h. The organic layer was collected and washed with water to remove the unreacted raw material and potassium chloride. The resulting organic layer was passed through a silica gel column to further remove metal ions, such as potassium ions, and halide ions, such as chloride ions and fluorine ions. The resulting organic layer was heated at 70° C. in vacuo to evaporate dichloromethane so as to give AEI-FSI.

### Preparation Example 2

### 1-allyl-3-ethylimidazolium bis(fluorosulfonyl)imide (AEI-FSI)

AMI-FSI was prepared as in Preparation Example 1 except that 1-allyl-3-methylimidazolium chloride (AMI-Cl) was used in place of AEI-Cl.

### Preparation Example 3

### 1-ethyl-3-n-propylimidazolium bis(fluorosulfonyl)imide (EPI-FSI)

EPI-FSI was prepared as in Preparation Example 1 except that 1-ethyl-3-n-propylimidazolium chloride (EPI-Cl) was used in place of AEI-Cl.

### <Measurement of Melting Points of Imidazolium Salts>

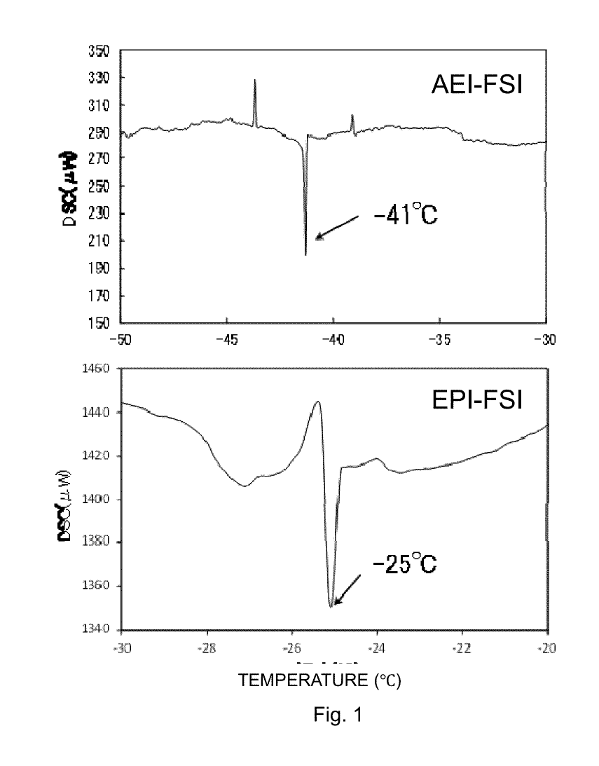

The melting points of AEI-FSI and EPI-FSI obtained in the synthesis of the above imidazolium salt were measured by performing DSC measurements (DSC6220 available from SII NanoTechnology Inc.) thereon. The results are illustrated in FIG. 1. While the melting point of AEI-FSI was −41° C., that of EPI-FSI was −25° C. That is, the melting point of AEI-FSI was lower than that of EPI-FSI by 16° C.

### <Measurement of Viscosities/Electric Conductivities of Imidazolium Salts>

The viscosity and the electric conductivity of the imidazolium salt were measured at −20° C., −10° C., and 0° C. using a digital rotational viscometer (VISCO STAR+ available from VISCOTECH CO., LTD.) and an electric conductivity meter (CM-30R available from DKK-TOA Corporation) in an ultra-low temperature thermostatic bath (TRL-080II available from THOMAS KAGAKU Co., Ltd.). The viscosities at 25° C. and 50° C. were measured using Cannon-Fenske viscometers (available from SIBATA SCIENTIFIC TECHNOLOGY LTD. and KUSANO SCIENCE CORPORATION) in a thermostatic bath (BF-200 available from Yamato Scientific Co., Ltd.). The electric conductivities at 25° C. and 50° C. were measured using the electric conductivity meter (described above) while adjusting the temperature using a hot plate (PC-320 available from Corning®).

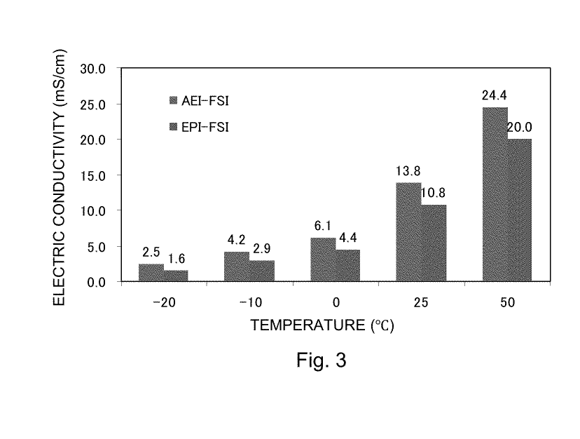

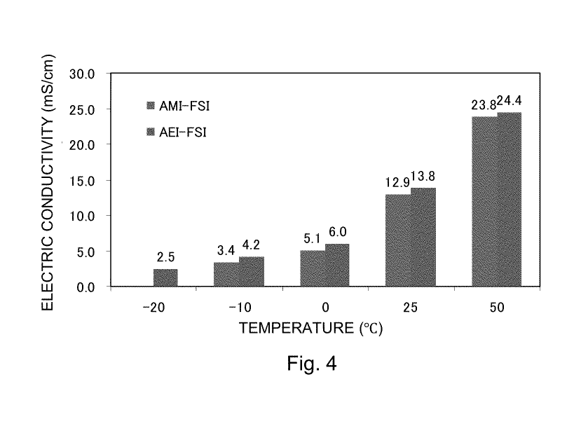

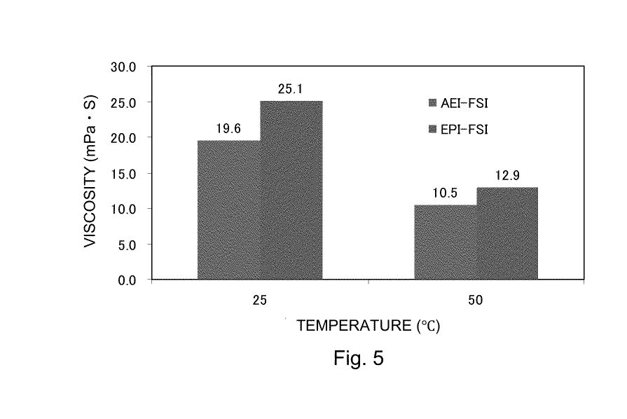

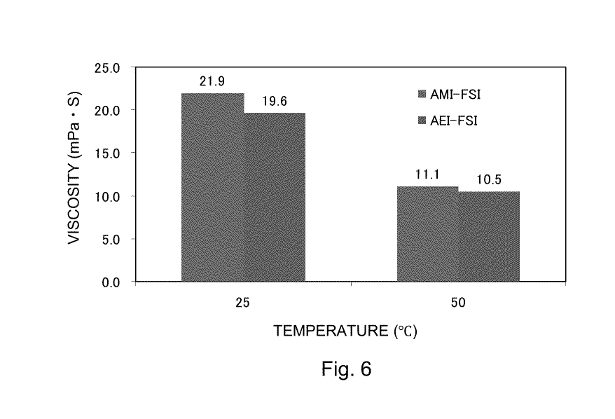

The viscosities and the electric conductivities of AEI-FSI, AMI-FSI, and EPI-FSI at the respective temperatures were measured. The measurement results are illustrated in Table 1 and FIGS. 3 to 6.

TABLE 1

| | | Prepa- | Prepa- | Prepa- |
|---|---|---|---|---|
| | | ration | ration | ration |
| Temperature | Measurement | Example 1 | Example 2 | Example 3 |
| (° C.) | item | AEI - FSI | AMI - FSI | PEI - FSI |
| −20 | Viscosity (mPa · s) | — | — | — |
| | Electric conductivity | 2.5 | Solidified | 1.6 |
| | (mS/cm) | | | |
| −10 | Viscosity (mPa · s) | — | — | — |
| | Electric conductivity | 4.2 | 3.4 | 2.9 |
| | (mS/cm) | | | |
| 0 | Viscosity (mPa · s) | — | — | — |
| | Electric conductivity | 6.1 | 5.1 | 4.4 |
| | (mS/cm) | | | |
| 25 | Viscosity (mPa · s) | 19.6 | 21.9 | 25.1 |
| | Electric conductivity | 13.8 | 12.9 | 10.8 |
| | (mS/cm) | | | |
| 50 | Viscosity (mPa · s) | 10.5 | 11.1 | 12.9 |
| | Electric conductivity | 24.4 | 23.8 | 20.0 |
| | (mS/cm) | | | |

At the respective temperatures, the viscosity of Preparation Example 1 was lower than those of Preparation Example 2 and Preparation Example 3. At the temperature within the range of 25° C. to 50° C., at which the battery is supposed to be actually used, the electric conductivities of Preparation Example 1 and Preparation Example 2 were higher than that of Preparation Example 3. That is, the electric conductivities when an allyl group was used as a substituent on a nitrogen atom were better than that when an n-propyl group was used. The electric conductivity of Preparation Example 1 was also better at the temperature within the range of −25 to 50° C. including the lower temperatures within the range of −20 to 0° C.

### <Measurements of Viscosities/Electric Conductivities of Electrolyte Solutions Containing 40 mol % of NaFSI>

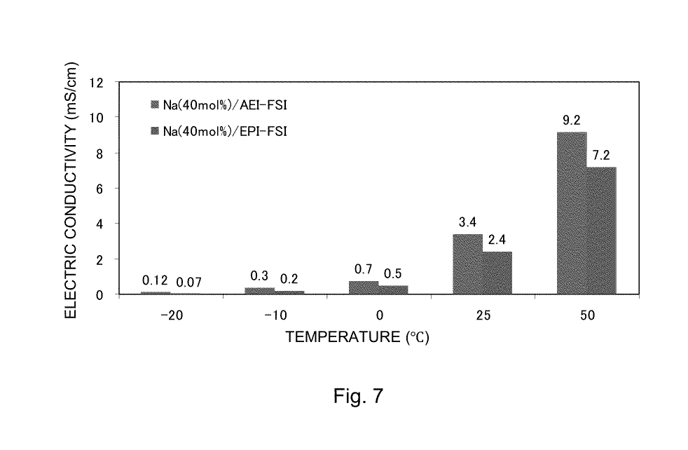

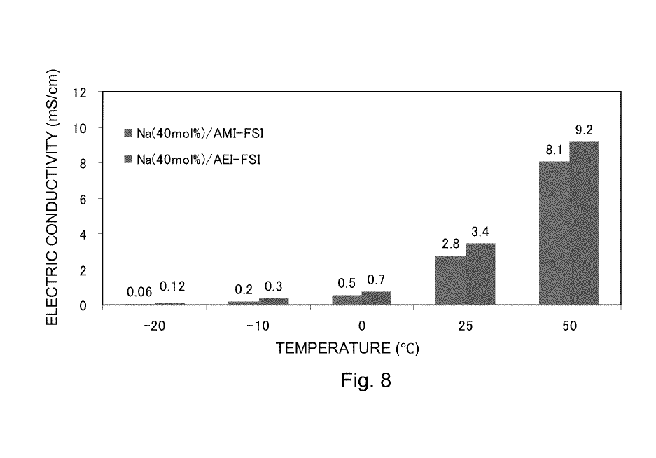

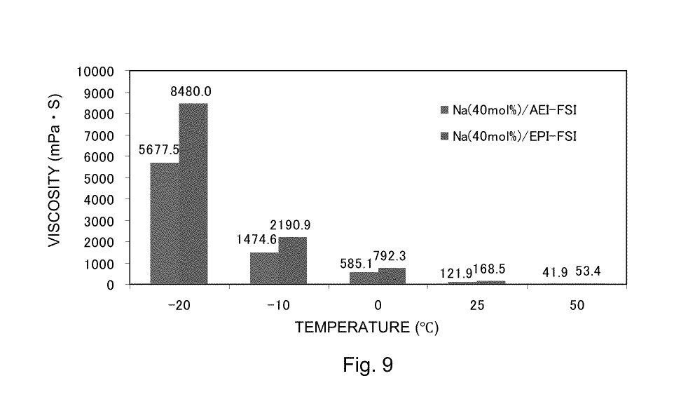

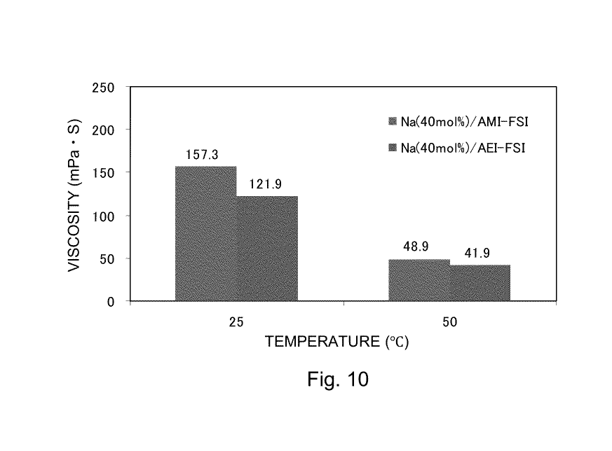

As with the imidazolium salt, the viscosities and the electric conductivities of electrolyte solutions containing 40 mol % of sodium bis(fluorosulfonyl)imide (NaFSI), which are AEI-FSI(Na(40 mol %)/AEI-FSI), AMI-FSI(Na(40 mol %)/AMI-FSI), and EPI-FSI(Na(40 mol %)/EPI-FSI), were measured at the respective temperatures. The measurement results are illustrated in Table 2 and FIGS. 7 to 10.

TABLE 2

| | | | | Comparative |
|---|---|---|---|---|
| | | Example 1 | Example 2 | Example 1 |
| | | Na(40 | Na(40 | Na(40 |
| Temperature | Measurement | mol %)/ | mol %)/ | mol %)/ |
| (° C.) | item | AEI - FSI | AMI - FSI | PEI - FSI |
| −20 | Viscosity (mPa · s) | 5677.5 | — | 8480.0 |
| | Electric conductivity | 0.12 | 0.06 | 0.07 |
| | (mS/cm) | | | |
| −10 | Viscosity (mPa · s) | 1474.6 | — | 2190.9 |
| | Electric conductivity | 0.3 | 0.2 | 0.2 |
| | (mS/cm) | | | |
| 0 | Viscosity (mPa · s) | 585.1 | — | 792.3 |
| | Electric conductivity | 0.7 | 0.5 | 0.5 |
| | (mS/cm) | | | |
| 25 | Viscosity (mPa · s) | 121.9 | 157.3 | 168.5 |
| | Electric conductivity | 3.4 | 2.8 | 2.4 |
| | (mS/cm) | | | |
| 50 | Viscosity (mPa · s) | 41.9 | 48.9 | 53.4 |
| | Electric conductivity | 9.2 | 8.1 | 7.2 |
| | (mS/cm) | | | |

At the respective temperatures, the viscosity of Example 1 was lower than those of Example 2 and Comparative Example 1. At the temperature within the range of 25° C. to 50° C., at which the battery is supposed to be actually used, the electric conductivities of Example 1 and Example 2 were higher than that of Comparative Example 1. That is, the electric conductivities when an allyl group was used as a substituent on a nitrogen atom were better than that when an n-propyl group was used. The electric conductivity of Example 1 was also better at the temperature within the range of −25 to 50° C. including the lower temperature within the range of −20 to 0° C. Thus, the electrolyte solutions of Examples 1 and 2 are believed to be more conducive to alleviating the increase in the internal resistance of the battery than the electrolyte solution of Comparative Example 1.

### <Calculation of Densities/Molecular Volumes>

The densities of AEI-FSI, AMI-FSI, and EPI-FSI at 20° C. were measured, and the molecular volumes thereof were obtained through calculations [calculation level: B3LYP/6-311++G(d)]. As for Na(40 mol %)/AEI-FSI, Na(40 mol %)/AMI-FSI, and Na(40 mol %)/AEI-FSI, the densities thereof were measured. The results are illustrated in Table 3.

TABLE 3

| | | | | Na(40 mol %)/ | Na(40 mol %)/ | Na(40 mol %)/ |
|---|---|---|---|---|---|---|
| | AEI-FSI | AMI-FSI | PEI-FSI | AEI-FSI | AMI-FSI | PEI-FSI |
| Density (g/cm³) | 1.39 | 1.43 | 1.36 | 1.55 | 1.60 | 1.53 |
| 20° C. | | | | | | |
| Molecular | 331 | 316 | 362 | — | — | — |
| volume (Å³) | | | | | | |
| Dissociation | −73.81 | −74.28 | −73.56 | | | |
| energy (kJ/mol) | | | | | | |

The densities (g/cm³) of AEI-FSI and AMI-FSI at 20° C. are preferably 1.37 to 1.45, more preferably 1.38 to 1.43, even more preferably 1.39 to 1.41. The reason is that when the density falls within the above ranges, the interionic interactions are moderate and thus the ions are three-dimensionally advantageously transported.

The molecular volume [calculation level: B3LYP/6-311++G(d)] is preferably 300 to 360 Å³, more preferably 310 to 350 Å³, even more preferably 320 to 340 Å³. The reason is that when the molecular volume falls within the above ranges, the interionic interactions are moderate and thus the ions are three-dimensionally advantageously transported.

### <Concentration of Sodium Ion-Containing Electrolyte and Viscosity/Electric Conductivity>

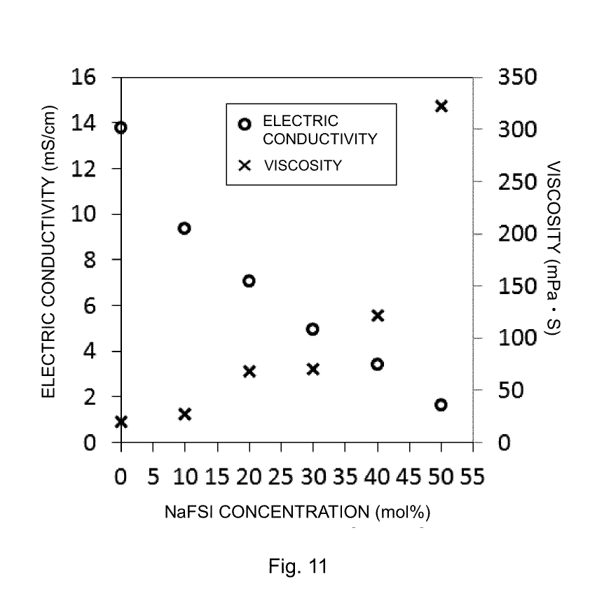

The electric conductivity and viscosity of AEI-FSI at 25° C. were measured while setting the NaFSI concentration to 0 to 50 mol %. The electric conductivity and viscosity of AEI-FSI in the respective NaFSI concentrations are illustrated in Table 4 and FIG. 11.

TABLE 4

| | |
|---|---|
| NaFSI | AEI - FSI |

| concentration | Electric conductivity | Viscosity |
|---|---|---|
| (mol %) | (mS/cm) | (mPa · s) |
| 0 | 13.8 | 19.6 |
| 10 | 9.4 | 27.9 |
| 20 | 7.1 | 67.8 |
| 30 | 4.9 | 70.5 |
| 40 | 3.4 | 121.9 |
| 50 | 1.6 | 322.3 |

What is claimed is:

1. An electrolyte solution for secondary batteries, comprising:
an allylimidazolium salt represented by General Formula (1); and
a sodium ion-containing electrolyte: 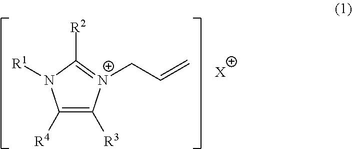
wherein R¹ is selected from the group consisting of: a linear, branched, or cyclic C1 to C10 alkyl group optionally substituted by a substituent; a linear, branched, or cyclic C2 to C10 alkenyl group optionally substituted by a substituent; a linear, branched, or cyclic C2 to C10 alkynyl group optionally substituted by a substituent; an aromatic hydrocarbon group optionally substituted by a substituent; an aromatic heterocyclic group optionally substituted by a substituent; and a univalent group having a heteroatom in a part of the alkyl group, the alkenyl group, or the alkynyl group;
R² to R⁴ may be the same or different and are each a hydrogen atom, or a hydrocarbon group optionally substituted by a substituent; and
X⁻ is a counter anion.

2. The electrolyte solution of claim 1, wherein the counter anion of the allylimidazolium salt is an anion represented by General Formula (2), 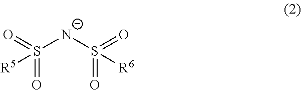
wherein R⁵ and R⁶ may be the same or different and are each a fluorine atom, or a hydrocarbon group in which at least one hydrogen atom may be optionally substituted by a fluorine atom.

3. The electrolyte solution of claim 1, wherein R¹ is a C1 to C10 alkyl group.

4. The electrolyte solution of claim 3, wherein R¹ is a C1 to C3 alkyl group.

5. The electrolyte solution of claim 1, wherein the counter anion of the allylimidazolium salt is a bis(fluorosulfonyl)imide anion.

6. The electrolyte solution of claim 1, wherein a concentration of the sodium ion-containing electrolyte is from 5 to 60 mol %.

7. A sodium ion secondary battery comprising the electrolyte solution of claim 1.
